(19) United States
(12) Patent Application Publication
(10) Pub. No.: US 2009/0169185 A1
(43) Pub. Date: Jul. 2, 2009

(54) OPTICAL DISK PLAYBACK APPARATUS AND METHOD FOR MANAGING DATA IN OPTICAL DISK PLAYBACK APPARATUS

(75) Inventor: Junichi Yoshizawa, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/242,429

(22) Filed: Sep. 30, 2008

(30) Foreign Application Priority Data
Dec. 28, 2007 (JP) 2007-339942

(51) Int. Cl. H04N 5/00

(52) U.S. Cl. 386/126; 386/E05.001

(57) ABSTRACT

An optical disc playback apparatus including: a reading section that reads data from an optical disc; a storage section that stores additional information in a first address of the storage section, the additional information corresponding to identification information included in data read from the optical disc by the reading section; an interface section that transfer the data stored in the storage section to a removable external storage device disposed outside the optical disc playback apparatus to be stored in a second address of the removal external storage device; and a table generator that generates a movement history table including the first address as a source address and the second address as a destination address when the additional information is transferred to the external storage device by the interface section.

### CROSS-REFERENCE TO RELATED APPLICATIONS

This application is based upon and claims the benefit of priority from Japanese Patent Application No. P2007-339942, filed Dec. 28, 2007, the entire contents of which are incorporated herein by reference.

### BACKGROUND

1. Field

One embodiment of the invention relates to an optical disc playback apparatus and more particularly to an optical disc playback apparatus connected to an external storage device and a method for managing data in the optical disc playback apparatus.

2. Description of the Related Art

An optical disc playback apparatus has recently become pervasive as a video playback system. Moreover, there has also been known a case where information related to content information in an optical disc is downloaded from a server by way of a network and utilized. A case where content information or relevant information is stored in an external storage device is also known.

JP-A-2006-228403 discloses a technique for generating management information used for identifying a recording medium at the time of copying or movement operation when contents are copied or moved to the recording medium in an information recording apparatus.

The related-art technique of JP-A-2006-228403 is one for merely recording data on an external device or restoring the data on a per-content basis. Information handled by an optical disc drive includes additional information; for example, a playlist of contents, relevant video information, and the like. When the volume of such additional information is increased, a built-in memory of a playback apparatus becomes deficient in capacity. For this reason, there is a problem of; for instance, a desire to operate and manage additional information, such as a playlist of contents and video information, on a per-provider-ID basis or a per-title-ID basis in each optical disc such as an HD_DVD.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example configuration of an optical disc playback apparatus of an embodiment;

FIG. 2 is an exemplary descriptive view showing an example P-Storage data structure of an optical disc handled by the optical disc playback apparatus of an embodiment;

FIG. 3 is an exemplary descriptive view showing an example movement history table handled by the optical disc playback apparatus of the embodiment;

FIG. 4 is an exemplary descriptive view showing an example inquiry screen provided for the user by the optical disc playback apparatus of the embodiment;

FIG. 5 is an exemplary flowchart showing example movement processing performed by the optical disc playback apparatus serving as an embodiment;

FIG. 6 is an exemplary flowchart showing example movement processing performed when the movement history table is provided in the memory section of the optical disc playback apparatus of the embodiment; and

FIG. 7 is an exemplary flowchart showing processing for automatically playing back additional information performed by the optical disc playback apparatus of the embodiment.

### DETAILED DESCRIPTION

Various embodiments according to the invention will be described hereinafter with reference to the accompanying drawings. In general, according to one embodiment of the invention, an optical disc playback apparatus includes: a reading section that reads data from an optical disc; a storage section that stores additional information in a first address of the storage section, the additional information corresponding to identification information included in data read from the optical disc by the reading section; an interface section that transfer the data stored in the storage section to a removable external storage device disposed outside the optical disc playback apparatus to be stored in a second address of the removal external storage device; and a table generator that generates a movement history table including the first address as a source address and the second address as a destination address when the additional information is transferred to the external storage device by the interface section.

An embodiment of the present invention will be described in detail hereunder by reference to the drawings.

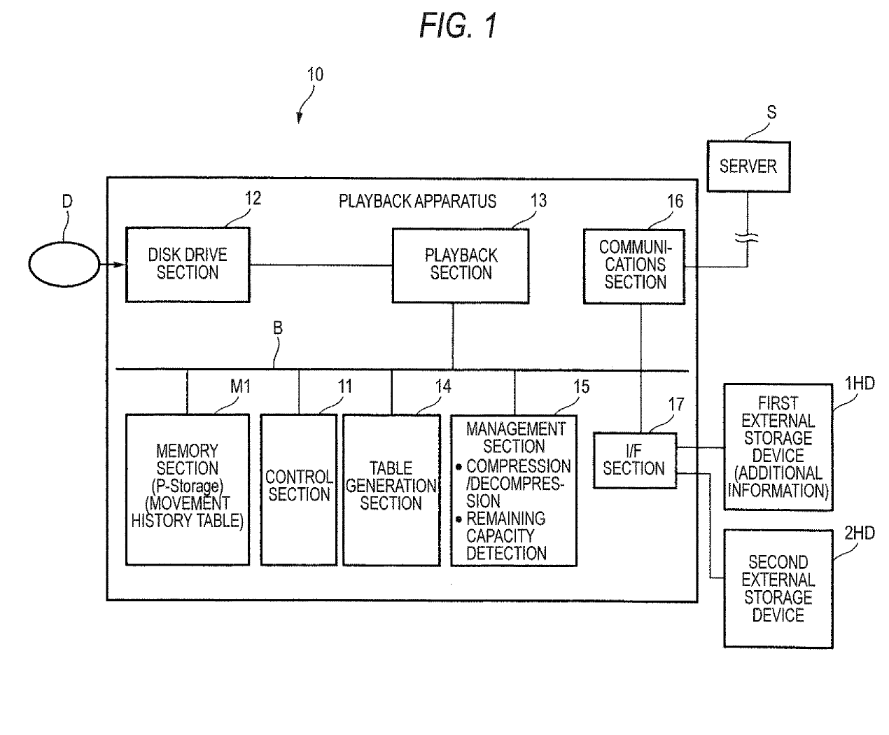

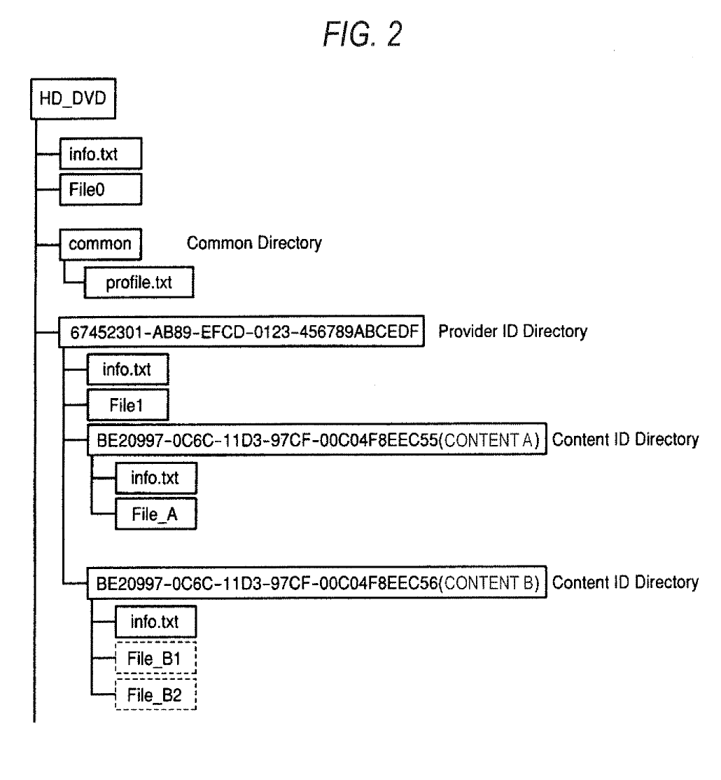

FIG. 1 is a block diagram showing an example configuration of an optical disc playback apparatus of an embodiment of the present invention. FIG. 2 is a descriptive view showing an example P-Storage data structure of an optical disc handled by the optical disc playback apparatus.

<Example Optical Disc Playback Apparatus Serving as an Embodiment of the Present Invention>

(Configuration)

As shown in FIG. 1, an optical disc playback apparatus 10 serving as an embodiment of the present invention has, by way of example, a disc drive section 12 that is loaded with an optical disc D, such as an HD_DVD (High Definition Digital Versatile Disc), and drives the disc, to thus read a content signal; a control section 11 for controlling overall operation; and a playback section 13 that plays back contents or video information corresponding to additional information to be described later.

Further, the optical disc playback apparatus 10 has a table generation section 14 for generating a movement table in order to move additional information to be described later to an external storage device; a movement management section 15 that performs compression/decompression processing, that detects remaining capacity of the external recording device 1HD, or the like, and that manages processing for moving the additional information, or like processing; a communications section 16 that establishes communication with the server S serving as an external device by way of an external network, such as the Internet; an interface section 17 for establishing communication with the outboard external storage device 1HD and an outboard external storage device 2HD; and a memory section M1 having a memory area where Persistent Storage (hereinafter called P-Storage), a movement history table, and the like, are recorded.

The word “P-Storage” is a term of HD_DVD standards and signifies a memory area where additional information, or the like, to be utilized during playback of an HD_DVD is stored. By way of example, the P-Storage is provided in a nonvolatile memory area, such as the memory section M1 of the optical disc playback apparatus 10.

The P-Storage is a memory area indispensable for equipment. However, the P-Storage is not an external extension, such as a USB (Universal Serial Bus), but a memory area in equipment. Therefore, the capacity of the P-Storage varies from one playback apparatus to another (the minimum capacity of the P-Storage is set to 128 MB in terms of standards). The P-Storage is usually implemented by flash memory. From the viewpoint of cost of a playback apparatus main unit, there are occasions where a P-Storage of small capacity is particularly used in a low-price player.

The word “additional information” includes, by way of example, playlist information set by the user, bookmark information about contents, motion image/still image information downloaded from a network, playlist information downloaded from a network, information about applications, and the like. The additional information is information to be utilized during playback of contents, or the like.

A general structure of the P-Storage will now be described. FIG. 2 is a descriptive view showing an example data structure of the P-Storage of the optical disc handled by the optical disc playback apparatus.

As shown in FIG. 2, the structure is determined by the HD_DVD standards, and the following information is handled.
Setting information and bookmark information about contents
Downloaded motion image/sound information
Captured still image

The P-Storage is logically built of a directory structure provided below.

Device Directory

A directory where information unique to a device is stored

Provider ID Directory

An area for storing information unique to a provider (a content provider)

A content provider is provided with a unique ID (GUID) and can make an access solely to a Provider ID Directory created in accordance with the ID and subsequent directories.

Content ID Directory

An area for storing information unique to contents

Data based on the user's preference, such as bookmark information of contents and information downloaded in connection with the contents, are stored in this area.

In relation to contents (Advanced Application), there is performed operation for storing or reading information in or from a storage device by utilization of a logical storage hierarchy.

Common Directory

An area for storing information common among providers or contents

An access can be made to the Common Directory in connection with all contents.

Next, principle types of information stored in the above areas in connection with the Advanced contents will be described. Use of the Advanced contents enables performance of operation for saving or reading the following information in or from the area in connection with the contents.
An XML file or a text file primarily having a size of tens of kilobytes

The file is used for storing a bookmark or setting information.
An image file (png, jpg, mng, and the like) primarily having a size of tens of kilobytes to several megabytes

Images for explaining a folder, or the like, are stored in the file.
A file for Advanced contents (XML, js, xmu, and xmf) primarily having a size of tens of kilobytes

Contents are stored in the file when updated by way of a network.
Motion-image/music file (wav, MAP, and EVO) primarily having a size of several megabytes to tens of megabytes

Bonus information of contents, or the like, are saved in the file when downloaded by way of a network

As mentioned above, the capacity of the P-Storage is finite and cannot be necessarily said to be large. Under such a circumstance, the HD_DVD standards or an HD_DVD playback apparatus enables copying of data to an external extended storage device in consideration of a case where data in the P-Storage comes to the maximum. In relation to the Advanced contents of the HD_DVD, data can be saved in the extended storage device by way of an API.

However, the memory area of the P-Storage is for being handled as a primary memory area in relation to the HD_DVD contents. Hence, if data in that memory area are readily moved to an external storage device, the user cannot easily restore user's personal preference information unique to the contents, which in turn raises a problem of the potential of the convenience of a user's viewing environment being impaired.

(Basic Operation)

In the optical disc playback apparatus 10 having such a configuration, management information and content information are read from; for instance, an HD_DVD loaded in the disc drive section 12, under control of the control section 11, and the content information is played back and output by the playback section 13. An ECMA script or a Markup language recorded in the HD_DVD disc enables performance of operation expected by the contents in the playback section 13 and the control section 11. When a read/write access is made, in relation to the contents, to the P-Storage to be described later, the access is implemented by the playback section 13 in the playback apparatus.

(P-Storage Movement Processing and Restoration Processing)

In relation to such a P-Storage, processing for moving and restoring data in the P-storage of the optical disc playback apparatus serving as an embodiment of the present invention is described in detail hereunder by use of a flowchart.

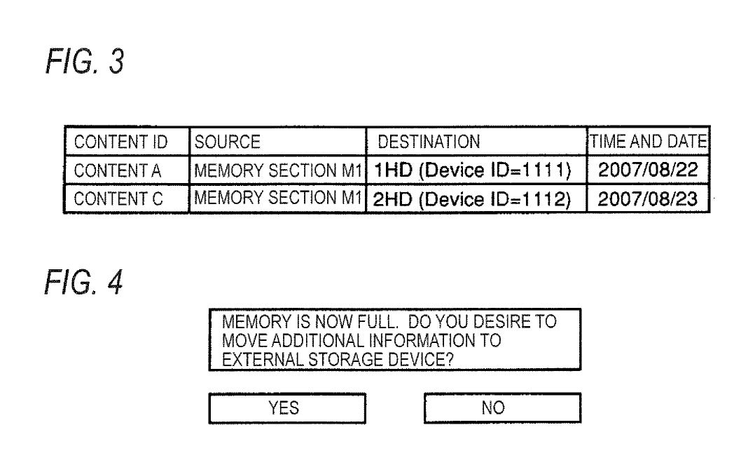

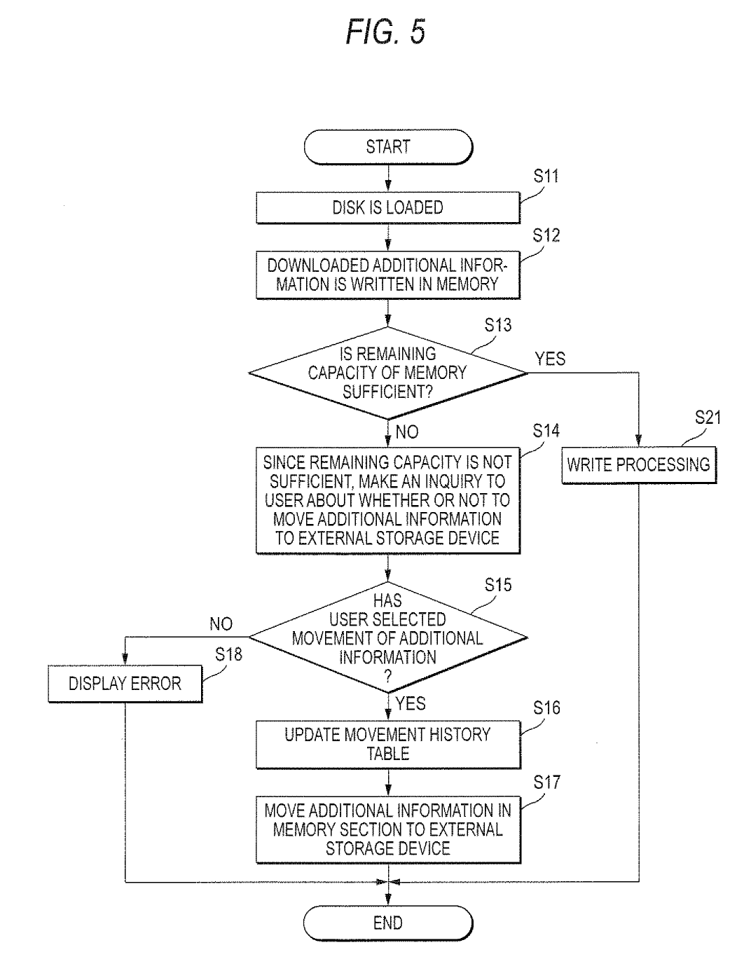

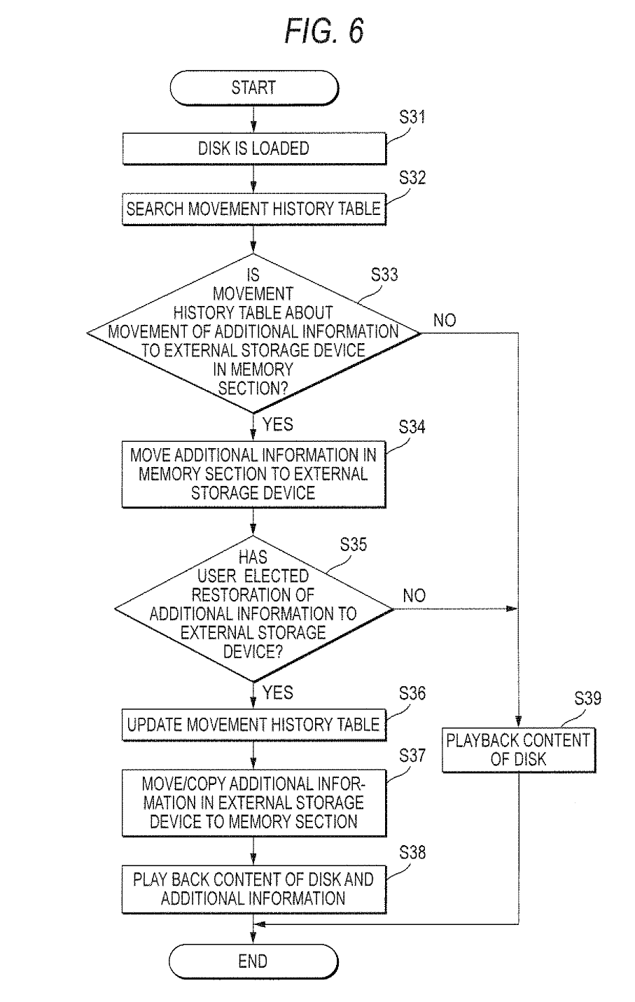

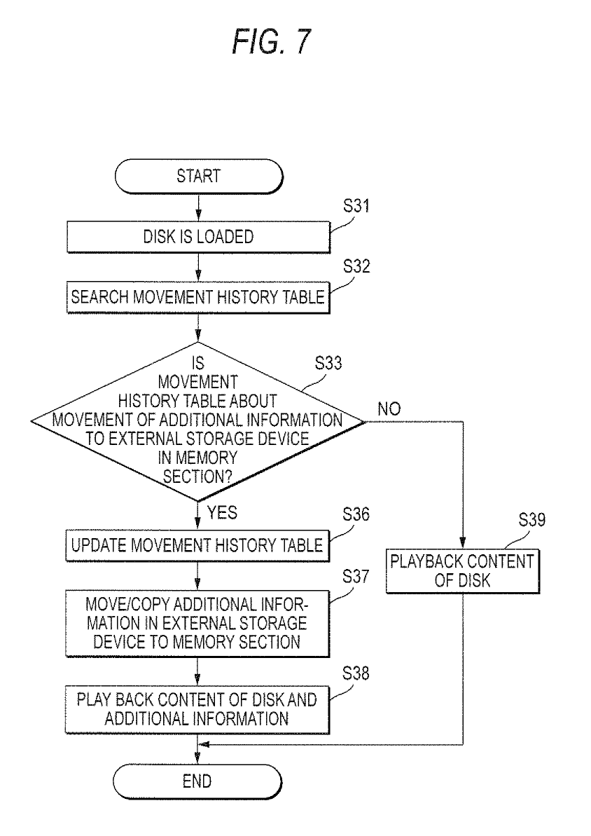

FIG. 3 is a descriptive view showing an example movement history table handled by the optical disc playback apparatus. FIG. 4 is a descriptive view showing an example inquiry screen provided for the user by the optical disc playback apparatus. FIG. 5 is a flowchart showing example movement processing performed by the optical disc playback apparatus serving as an embodiment of the present invention. FIG. 6 is a flowchart showing example movement processing performed when the movement history table is provided in the memory section of the optical disc playback apparatus. FIG. 7 is a flowchart showing processing for automatically playing back additional information performed by the optical disc playback apparatus.

Respective steps of the flowcharts shown in FIGS. 5 through 7 provided below can be replaced with circuit blocks. Accordingly, all of the steps of the respective flowcharts can be defined as circuit blocks.

(Movement Processing)

First, example movement processing of the P-Storage will be described by reference to the flowchart shown in FIG. 5. In the optical disc playback apparatus 10, an HD_DVD disc, for instance, is assumed to be first loaded in the disc drive section 12 (step S11). Under control of the control section 11, the disc drive section 12 reads, from the optical disc D, a Provider ID corresponding to identification information and a Content ID corresponding to content information.

Next, during playback of contents stored in the optical disc D, advanced application for the contents is assumed to have made an attempt to write some type of data in the P-Storage (step S12). The data are generically called additional information. As mentioned above, by way of example, the additional information may be bookmark information created by the user, an additional image or a playlist associated with content information downloaded from the server S by the communications section 16 by way of an external network, such as the Internet, in accordance with an address provided in content information in the disc, and the like.

In this case, additional information (management information such as video information, a playlist, and the like) unique to the contents is saved in the Content ID Directory shown in FIG. 2. When the user saved the additional information unique to the content A in the P-Storage, the state of the P-Storage becomes as shown in FIG. 2.

Next, as shown in FIG. 2, the user is assumed to view a content B that is a different content, and an application for the content is assumed to have attempted to write additional information, such as that mentioned above, in the P-Storage.

At this time, the control section 11 and the residual capacity detection function of the movement management section 15 determine whether or not capacity sufficient for writing the additional information is available in the memory section M1 (step S13). When the control section ST and the residual capacity detection function of the movement management section 15 determine that sufficient capacity is available in the memory section M1, processing for normally writing additional information is performed and completed (step S21).

However, when determined that sufficient capacity is not available in the memory section M1, the control section 11 and the residual capacity detection function of the movement management section 15 generates an image signal for a screen to this effect, such as that shown in FIG. 4, thereby inquiring about the user's intension of movement (step S14).

At this time, it is preferable that details of the current P-Storage and a list of information in an available external storage device be displayed on a screen and that a screen for moving or copying the file to a desired location be further displayed for the user.

When the user imparts a movement command signal to the control section 11, or the like, by way of the operation section, or the like, in accordance with the screen (step S15), the table generation section 14 provides a movement history table, such as that shown in FIG. 3, and records and updates a movement history in conjunction with information about an ID of a moved content, a source (the name of a device), a destination (the name of a device), a date and time, and the like (step S16) Not only simple storage of the name of a restarted device but also detailed description of an address of a memory area of the device are also preferable. The movement history table is stored in; for example, the memory section M1 or the like.

Next, the control section 11 and the management section 15 move the additional information (content information or management information such as a playlist) designated for movement; for instance, additional information pertaining to a content A, to the first external storage device 1HD connected to the sections by way of; for example, the I/F section 17 (step 317). At this time, it is preferable that additional information be moved to the first external storage device 1HD, or the like, after being compressed by use of a compression function provided in the management section 15.

However, in step S15, the additional information is not stored unless there is a user's command for movement, and processing will be completed by providing; for example, an error display (step S18).

When movement is performed, available capacity of the P-Storage of the storage section M1 is increased. Hence, the user can record additional information pertaining to the content B in the P-Storage. Thus, an available space is created in the P-Storage, and the user can record information about the content B in the P-Storage.

(Restoration Processing)

Example processing for restoring additional information in the P-Storage will now be described by use of a flowchart shown in FIG. 6. For instance, an HD_DVD is assumed to be loaded in the disc drive section 12 of the optical disc playback apparatus 10 (step S31). Under control of the control section 11, identification information about the disc; for instance, the Provider ID and the Content ID, is read. Specifically, it is seen that the user has again inserted the previously-viewed disc of the content A.

On the basis of the identification information, the control section 11 and the movement management section 15 retrieve the movement history table of the memory section M1 (step S32). When perceived that the management information about the content A is present in the movement history table and that additional information about the content A has already been moved to the external storage device 1HD, and the like (step S33), the control section 11 and the movement management section 15 make an inquiry to the user about whether or not to return the data in the external storage device 1HD to the memory section M1 (step S34). If corresponding management information is not present in the movement history table, the additional information will not be recovered and playback of a content of an ordinary optical disc is performed (step S39).

However, if corresponding management information is present in the movement history table and if the user has received a signal for commanding restoration of additional information to the memory section M1 (step S35), the control section 11, the table generation section 14, and the management section 15 will update the movement history table in the memory section M1, to thus update the table in order to record restoration of the additional information (in a case where the additional information is moved) (step S36). The control section 11 and the management section 15 moves or copies the additional information in the external storage device 1HD to the memory section M1 by use of the I/F section 17 (step S37). At this time, it is preferable for the management section 15 to decompress the additional information compressed by the compression/decompression function.

Subsequently, the control section 11 and the playback section 13 plays back the content of the optical disc D and the additional information or plays back solely the additional information (step S38).
Automatic Restoration Processing

As mentioned above, by means of the operation screen pertaining to step S34, there is made an inquiry to the user about whether or not to restore the data in the external storage device to the memory section M1. When a command is received, the additional information is restored. However, as indicated by the flowchart shown in FIG. 7, it is also preferable that additional information be immediately added, to thus be automatically restored, after detection of presence of additional information without displaying such an inquiry screen.

Specifically, in step S33 of the flowchart shown in FIG. 7, it is also preferable that, when perceived that the management information about the content A is present in the movement history table and that the additional information about the content A has already been moved to the external storage device 1HD, or the like, the controls section 11 and the movement management section 15 immediately move or copy the data in the external storage device 1HD to the memory section M1 by use of the interface section 17 (step S37).

As a result, the user can view a playback of content information and additional information by unconscious use of additional information in the external storage device 1HD without performing laborious operation. Descriptions commonly provided in FIG. 6 are omitted.

Although the above embodiment has mentioned the optical disc playback apparatus for an HD_DVD, the present invention can be applied to an optical disc playback apparatus, so long as the apparatus has a similar structure.

The present invention can also be implemented under the initiative of a player or advanced application.

Those who are versed in the art can implement the present invention by means of the foregoing various embodiments. However, it is easy for the person skilled in the art to further conceive various alterations of the embodiments and to be able to apply the present invention to various embodiments without inventive capability. Accordingly, the present invention encompasses a wide range that is not contradictory to the disclosed principle and novel features and is not limited to the above-described embodiments.

As described with reference to the embodiment, there in provided an optical disc playback apparatus capable of moving additional information, such as a playlist, to an external storage device and managing the information on a per-management-information basis, as well as providing a method for managing data in the optical disc playback apparatus.

When built-in memory of a playback apparatus becomes deficient in capacity as a result of an increase in the volume of additional information, such as a playlist, in each optical disc, additional information, or the like, is moved to an external storage device. When playback is performed, the additional information can be immediately read and used.

What is claimed is:

1. An optical disc playback apparatus comprising:
a reading section that reads data from an optical disc;
a storage section that stores additional information in a first address of the storage section, the additional information corresponding to identification information included in data read from the optical disc by the reading section;
an interface section that transfer the data stored in the storage section to a removable external storage device disposed outside the optical disc playback apparatus to be stored in a second address of the removal external storage device; and
a table generator that generates a movement history table including the first address as a source address and the second address as a destination address when the additional information is transferred to the external storage device by the interface section.

2. The apparatus according to claim 1, wherein the identification information includes identification information about a content provider and identification information about a content.

3. The apparatus according to claim 1 further comprising a management section that reads, on the basis of the source address and the destination address, the additional information from the external storage device by using the interface section.

4. The apparatus according to claim 1 further comprising a management section that generates image making an inquiry about whether or not to transfer the additional information from the storage section to the external storage device and that is configured to transfer the additional information stored in the storage section to the external storage device when an answer of the inquiry indicates transferring the additional data.

5. The apparatus according to claim 1, wherein the additional information includes at least one of playlist information relevant to content information stored in the optical disc, bookmark information about the content information, motion-image/still-image information relevant to the content information, and an application relevant to the content information.

6. The apparatus according to claim 1 further comprising a management section that is configured to search the identification information about the optical disc when loaded with the optical disc, and to read the additional information from the external storage device on the basis of the destination address indicated by the movement history table when detected the movement history table corresponding to the identification information.

7. The apparatus according to claim 1, wherein the management section includes a compressor configured to compress the additional information before the additional information is transferred to the external storage device so that the compressed additional information is stored in the external storage device and decompressor configured to decompress the compressed additional information when the compressed additional information is played back.

8. A processing method for information stored in an optical disc, the method comprising:
reading data from the optical disc;
storing additional information in a first address of a storage section, the additional information corresponding to identification information included in data read from the optical disc;
transferring the data stored in the storage section to a removable external storage device to store the transferred data in a second address of the removal external storage device; and
generating a movement history table including the first address as a source address and the second address as a destination address before the additional information is transferred to the external storage device.

9. The method according to claim 8, wherein the transferring step is performed based on the movement history table.

10. The method according to claim 8, wherein the additional information includes at least one of playlist information relevant to content information stored in the optical disc, bookmark information about the content information, motion-image/still-image information relevant to the content information, and an application relevant to the content information.

11. The method according to claim 8 further comprising:
searching the movement history table corresponding to identification information about a disc when the disc is reloaded; and
reading the additional information from the external storage device on the basis the movement history table when the searched movement history table is exist.
